(19) United States
(12) Patent Application Publication
(10) Pub. No.: US 2012/0092800 A1
(43) Pub. Date: Apr. 19, 2012

(54) CIRCUIT FOR DETECTING OVER-VOLTAGE AND OVER-CURRENT

(76) Inventor: Ti-Hua Ko, Taipei (TW)

(21) Appl. No.: 12/904,139

(22) Filed: Oct. 13, 2010

(51) Int. Cl. H02H 3/38

(52) U.S. Cl. 361/91.2

(57) ABSTRACT

A circuit adapted for detecting over-voltage and over-current includes a first voltage-dividing resistor having one terminal connected with a DC power circuit and the other terminal connected to ground through a second voltage-dividing resistor, a current-detecting resistor having one terminal connected with the DC power circuit and the other terminal designated as an output node, a voltage regulator having one terminal connected to the output node and the other terminal is connected to ground, and a comparator which has a non-inverting input connected at the joint of the voltage regulator and the output node, an inverting input connected at the joint of the voltage-dividing resistors, and an output connected with the DC power circuit for transmitting a control signal to control work states of the DC power circuit according to a voltage comparison result of the non-inverting input with the inverting input.

### BACKGROUND OF THE INVENTION

1. Field of the Invention

The present invention generally relates to a detection circuit, and more particularly to a circuit for detecting over-voltage and over-current.

2. The Related Art

During designing circuits of various electronic devices, a detection function for detecting a current through a load is often needed in the circuit so as to avoid the load being damaged by an excessive current. However, the design for detecting the current through the load may not be perfect in the ordinary circuit. For example, when the traditional detecting circuit works at an overload condition, the excessive current may often flow in the circuit and not be stopped by the circuit. As a result, circuit components are apt to be damaged.

### SUMMARY OF THE INVENTION

An object of the present invention is to provide a circuit adapted for detecting over-voltage and over-current for overcoming the drawback in the prior art. The detecting circuit is connected with a DC power circuit which has an output port and a drive port receiving a control signal from the detecting circuit. The detecting circuit includes a first voltage-dividing resistor having one terminal connected with the output port of the DC power circuit and the other terminal connected to ground through a second voltage-dividing resistor, a current-detecting resistor having one terminal connected with the output port of the DC power circuit and the other terminal designated as an output node for connecting with an external load, a voltage regulator with a breakdown voltage of which one terminal is connected to the output node and the other terminal is connected to ground, and a comparator having an inverting input, a non-inverting input and an output. The joint of the first voltage-dividing resistor and the current-detecting resistor is designated as a detecting node having a potential equal to the sum of the voltage at the output node and that of the current-detecting resistor. The inverting input of the comparator is connected at the joint of the first voltage-dividing resistor and the second voltage-dividing resistor for getting an input voltage equal to a potential between the first voltage-dividing resistor and the second voltage-dividing resistor after the potential at the detecting node is divided by the voltage-dividing resistors. The non-inverting input is connected at the joint of the voltage regulator and the output node so as to get another input voltage by means of comparing the voltage at the output node with the breakdown voltage of the voltage regulator. The output of the comparator is connected with the drive port of the DC power circuit so as to transmit a control signal to control work states of the DC power circuit according to a voltage comparison result of the non-inverting input with the inverting input.

As described above, the detecting circuit of the present invention can efficiently detect whether the DC power circuit outputs an over-voltage or an over-current and further control the DC power circuit to keep or stop working according to the detected result, by means of the cooperation of the voltage regulator and the comparator, rather than minding whether an overload is connected with the output node. So, it can avoid the DC power circuit and the load being damaged as a result of transmitting and receiving over-current and over-voltage.

### BRIEF DESCRIPTION OF THE DRAWINGS

The present invention will be apparent to those skilled in the art by reading the following description, with reference to the attached drawings, in which:

FIG. 1 is a circuitry of a circuit for detecting over-voltage and over-current in accordance with the present invention.

### DETAILED DESCRIPTION OF THE PREFERRED EMBODIMENT

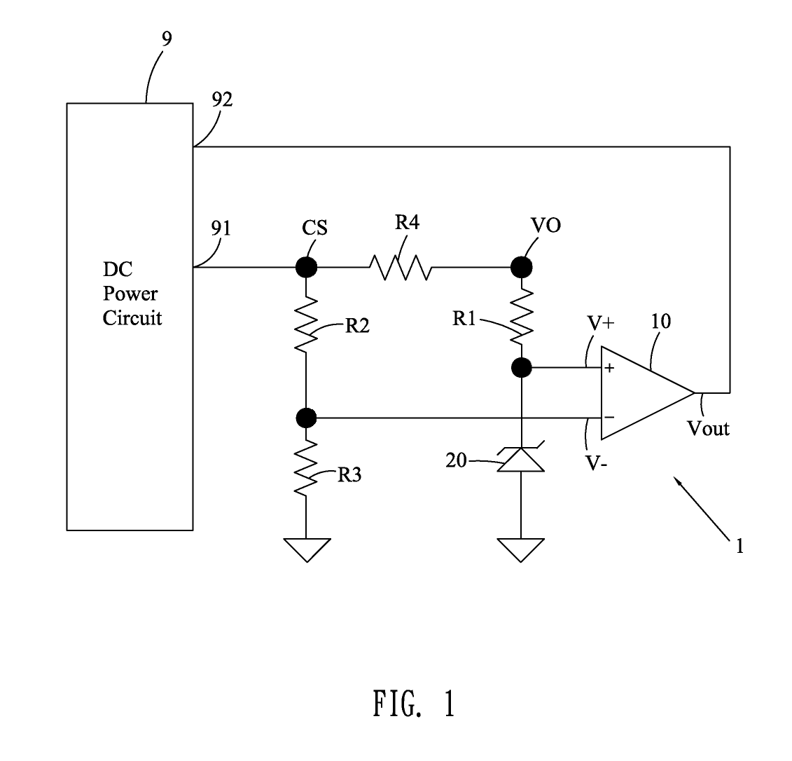

To explain the technical contents, structural features, attained objects and effects of the present invention in detail, embodiments accompanying with figures are presented below. Referring to FIG. 1, a circuit 1 for detecting over-voltage and over-current is connected with a DC power circuit 9. The DC power circuit 9 has an output port 91 capable of outputting a DC voltage and a DC current, and a drive port 92 receiving a control signal from the circuit 1 so as to control the DC power circuit 9 to keep or stop outputting the DC voltage and the DC current. In practical applications, the DC power circuit 9 may be a boosting circuit or a step-down circuit. The circuit 1 includes a comparator 10, a voltage regulator 20, a current-limiting resistor R1, a first voltage-dividing resistor R2, a second voltage-dividing resistor R3 and a current-detecting resistor R4.

In FIG. 1, one terminal of the current-detecting resistor R4 and that of the first voltage-dividing resistor R2 are connected with each other and further connected to the output port 91 of the DC power circuit 9, wherein the joint of the current-detecting resistor R4, the first voltage-dividing resistor R2 and the output port 91 is designated as a detecting node CS. The other terminal of the first voltage-dividing resistor R2, on one hand is connected to ground through the second voltage-dividing resistor R3, and on the other hand is connected with the inverting input V− of the comparator 10. The other terminal of the current-detecting resistor R4 is connected with one terminal of the current-limiting resistor R1, and an output node VO is designated at the joint of the current-detecting resistor R4 and the current-limiting resistor R1. The output node VO is used to connect with an external load (not shown). The other terminal of the current-limiting resistor R1, on one hand is connected with the non-inverting input V+ of the comparator 10, and on the other hand is connected to ground through the voltage regulator 20. In this embodiment, the voltage regulator 20 is a zener diode of which the cathode is connected with the current-limiting resistor R1 and the anode is connected to ground. The output Vout of the comparator 10 is connected to the drive port 92 of the DC power circuit 9 so as to transmit a control signal to control work states of the DC power circuit 9 according to a voltage comparison result of the non-inverting input V+ with the inverting input V− of the comparator 10.

Now take description to the working principle of the circuit 1 in the following conditions, wherein the first voltage-dividing resistor R2 has a 1Ω resistance, the second voltage-dividing resistor R3 has a 7Ω resistance, the current-detecting resistor R4 has a 0.5Ω resistance, the zener diode has a breakdown voltage of 5.6V, the output node VO outputs 5V voltage and the output port 91 outputs 1 A current when the DC power circuit 9 is at a normal work state. The potential at the detecting node CS is equal to the sum of the voltage at the output node VO and that of the current-detecting resistor R4, namely 5.5V in this embodiment when the DC power circuit 9 is at the normal work state. The inverting input V− of the comparator 10 has an input voltage equal to a potential between the first voltage-dividing resistor R2 and the second voltage-dividing resistor R3 after the potential at the detecting node CS is divided by the first voltage-dividing resistor R2 and the second voltage-dividing resistor R3, namely has a 4.8125V voltage when the potential at the detecting node CS is 5.5V. In this embodiment, the resistance of the current-limiting resistor R1 is so low that the voltage drop across the current-limiting resistor R1 could be ignored. So, the voltage provided for the non-inverting input V+ of the comparator 10 is substantially equal to the voltage at the output node VO, namely 5V, on account of the voltage at the output node VO being lower than the breakdown voltage of the zener diode. Because the non-inverting input V+ is at a higher voltage than the inverting input V−, the output Vout of the comparator 10 outputs a positive voltage signal for the drive port 92 so as to control the DC power circuit 9 to keep working.

When an over-current is output by the output port 91 of the DC power circuit 9 and the voltage at the output node VO is still 5V, for example the output port 91 outputs a 1.6 A over-current in this embodiment, then the voltage provided for the non-inverting input V+ of the comparator 10 is still 5V because the voltage at the output node VO is lower than the breakdown voltage of the zener diode. However, those cause the potential at the detecting node CS to be 5.8V, and make the voltage of the inverting input V− of the comparator 10 rise up to 5.075V. As a result, because the non-inverting input V+ is at a lower voltage than the inverting input V−, the output Vout of the comparator 10 outputs a negative voltage signal for the drive port 92 so as to control the DC power circuit 9 to stop working, namely stop outputting over-current.

When an over-voltage is output by the DC power circuit 9 and the current output by the output port 91 is still 1 A, for example a 6V over-voltage is provided at the output node VO in this embodiment, then the potential at the detecting node CS is accordingly changed into 6.5V, and the voltage of the inverting input V− of the comparator 10 accordingly rises up to 5.6875V. Because the voltage at the output node VO is higher than the breakdown voltage of the zener diode, the voltage of the non-inverting input V+ of the comparator 10 is equal to the breakdown voltage of the zener diode, namely 5.6V. As a result, the non-inverting input V+ is at a lower voltage than the inverting input V−. So, the output Vout of the comparator 10 outputs the negative voltage signal for the drive port 92 so as to control the DC power circuit 9 to stop working, namely stop outputting over-voltage.

As described above, the circuit 1 can efficiently detect whether the DC power circuit 9 outputs an over-voltage or an over-current and further control the DC power circuit 9 to keep or stop working according to the detected result, by means of the cooperation of the voltage regulator 20 and the comparator 10, rather than minding whether an overload is connected with the output node VO. So, it can avoid the DC power circuit 9 and the load being damaged as a result of transmitting and receiving over-current and over-voltage.

What is claimed is:

1. A circuit adapted for detecting over-voltage and over-current connected with a DC power circuit, the DC power circuit having an output port and a drive port receiving a control signal from the circuit, the circuit comprising:
a first voltage-dividing resistor having one terminal connected with the output port of the DC power circuit and the other terminal connected to ground through a second voltage-dividing resistor;
a current-detecting resistor having one terminal connected with the output port of the DC power circuit, and the other terminal designated as an output node for connecting with an external load, the joint of the current-detecting resistor and the first voltage-dividing resistor being designated as a detecting node having a potential equal to the sum of the voltage at the output node and that of the current-detecting resistor;
a voltage regulator of which one terminal is connected to the output node and the other terminal is connected to ground, the voltage regulator having a breakdown voltage; and
a comparator having an inverting input, a non-inverting input and an output, the inverting input being connected at the joint of the first voltage-dividing resistor and the second voltage-dividing resistor for getting an input voltage equal to a potential between the first voltage-dividing resistor and the second voltage-dividing resistor after the potential at the detecting node is divided by the voltage-dividing resistors, the non-inverting input being connected at the joint of the voltage regulator and the output node so as to get another input voltage by means of comparing the voltage at the output node with the breakdown voltage of the voltage regulator, the output of the comparator being connected with the drive port of the DC power circuit so as to transmit a control signal to control work states of the DC power circuit according to a voltage comparison result of the non-inverting input with the inverting input.

2. The circuit as claimed in claim 1, wherein the input voltage of the non-inverting input is equal to the voltage at the output node when the voltage at the output node is lower than the breakdown voltage of the voltage regulator, on the contrary, the input voltage is equal to the breakdown voltage of the voltage regulator when the voltage at the output node is higher than the breakdown voltage of the voltage regulator.

3. The circuit as claimed in claim 1, wherein the output of the comparator outputs a positive voltage signal for the drive port so as to control the DC power circuit to keep working when the non-inverting input is at a higher voltage than the inverting input, on the contrary, the output of the comparator outputs a negative voltage signal for the drive port so as to control the DC power circuit to stop working when the non-inverting input is at a lower voltage than the inverting input.

4. The circuit as claimed in claim 1, wherein the voltage regulator is a zener diode of which the cathode is connected to the output node and the anode is connected to ground.

5. The circuit as claimed in claim 1, further comprising a current-limiting resistor connected between the output node and the voltage regulator, the non-inverting input of the comparator being further connected at the joint of the current-limiting resistor and the voltage regulator, wherein the resistance of the current-limiting resistor is so low that the voltage drop across the current-limiting resistor is ignored, so the input voltage of the non-inverting input is substantially equal to the voltage at the output node when the voltage at the output node is lower than the breakdown voltage of the voltage regulator, on the contrary, the input voltage is equal to the breakdown voltage of the voltage regulator when the voltage at the output node is higher than the breakdown voltage of the voltage regulator.
